(19) United States
(12) Patent Application Publication
(10) Pub. No.: US 2009/0114861 A1
(43) Pub. Date: May 7, 2009

(54) CONTROL SYSTEM FOR DYNAMIC ORIFICE VALVE APPARATUS AND METHOD

(76) Inventors: Paul Luebbers, Dunlap, IL (US); Matthew Anderson Winkler, Metamora, IL (US); Adam Charles Steven, Washington, IL (US)

Correspondence Address: HUSCH BLACKWELL SANDERS LLP, 190 CARONDELET PLAZA, SUITE 600, ST. LOUIS, MO, 63105-3441, US

(21) Appl. No.: 12/254,612

(22) Filed: Oct. 20, 2008

Related U.S. Application Data
(63) Continuation-in-part of application No. 11/854,224, filed on Sep. 12, 2007.

(51) Int. Cl. F16K 31/02

(52) U.S. Cl. 251/129.11

(57) ABSTRACT

In a fluid transmission line, a valve comprising a housing that establishes a lumen for transmission of a fluid through said valve; a drive mechanism and a drive gear mounted in said housing to be selectively driven in a first or second rotational direction by said drive mechanism. The drive gear has a central throughhole and a plurality of pins around the central throughhole. A plurality of leaves are pivotally mounted on the pins, and oriented to extend radially inward into said central throughhole. A fixed extension has an annular aspect disposed in the drive gear, and has a plurality of engagement members disposed to operatively engage one of said leaves. The engagement members bias the leaves to close an orifice when said drive gear rotates in said first direction and to open the orifice when said drive gear rotates in said second direction. Each of the leaves maintains a substantially sealing engagement with each adjacent leaf throughout a range of motion of the leaves.

### CROSS-REFERENCE TO RELATED APPLICATIONS

This application is a continuation-in-part of U.S. patent application Ser. No. 11/854,224 filed on Sep. 12, 2007.

### BACKGROUND OF THE INVENTION

1. Field of the Invention

The field of this invention is in valves for fluid and gas flow, particularly natural gas.

2. Related Art

The flow of the fluids and gases being piped through lines is typically controlled with valves. The valves of course control flow through a pipe by obstructing the pipe in one form or another. In the prior art, the form of obstruction is asymmetrical. For example if a simple screw or needle type valve mechanically advances a gate or needle into a cylinder from one side. Even well-known butterfly valves are symmetrical in one direction, but asymmetrical in another, in that half of the butterfly disk advances towards the source of flow while the other half recedes away from it.

The effect on the flow of the fluid gases that is created by the simple mechanical devices is also asymmetrical, irregular and unpredictable. Generally, it is desirable to have more symmetrical fluid flow throughout the range of constriction that a valve is designed to achieve. This promotes a more rapid return to laminar flow, reduces friction, avoids obstruction from contaminants, reduces back pressure and enables more accurate flow rate and pressure control. More particularly, in some applications, particularly pressurized applications for gas, there is a desirability and need for a symmetrical and therefore more precise constriction of gas flow in order to promote predictably and accuracy of use of the gas thereby making its use more economical across all ranges of pressure and volume to be executed by the valve.

Most particularly, some applications of natural gas use, for example, heat treatment of production material, most especially heat treatment of ferrous metals, requires an optimally precise control of gas flow. More particularly still, a gas flow is combined with gas or air in order to achieve a precise control of how lean or rich will be the output of the gas line for combustion in the heat treating chamber. Precise control of how lean or rich the gas output into the heating chamber is important because the chemical and rheological properties of the metal being treated are sensitive to the chemical atmosphere in the chamber which in turn is dependent upon the gas/air mixture received from the gas line.

FIG. 1, depicting a prior art natural gas burner assembly (10) shows the natural gas line (12) in combination with an air or oxygen line (14). The air line (14) is controlled by a butterfly valve (16). Downstream of the butterfly valve, a flow sensor control (18) controls an impulse valve (20) in the gas line (10). If any fine adjustment is needed, a needle valve (22) is fitted downstream of gas line (10). This is an example of an unintegrated assembly created from separate components. A disadvantage of such an assembly is that the final output does not vary proportionally with adjustment of controls. In prior art valves, such as valve 16 in FIG. 1, the amount of flow allowed to pass varies with opening in an unpredictable fashion that is not continuously proportional to the progressive opening or closing of the valve. The volume, pressure and turbulence of flow are not mathematically predictable or precisely controllable. Accordingly, in the prior art application illustrated, the mixture of the gas/air combination is also unpredictable and poorly controlled. The volume of flow as a function of the percentage of opening of a valve is complex, difficult to model, variable over time and sometimes discontinuous.

Control systems for process valves were typically driven by AC power in the prior art and used to operate components such as relays and the like. Efficiency and precision were limited. Valve position was typically monitored by using a slide wire and potentiometer wire contacting the coil of a motor. Such components had a finite life span, and typically required shut down of the process for repair.

Another long term disadvantage of prior art devices was flutter. Flutter occurs when a control circuit unnecessarily cycles in response to inconsequential changes in the process parameter being measured to control a valves position. For example, if the process parameter is temperature in a furnace, prior art systems tended to respond to trivial temperature variations, for example, one degree change in a first direction. After the control system caused the valve to respond, a one degree change in an opposite direction would be sensed, and the control system would respond to that, creating a continuous loop of control, motor and valve operation. This needless cycling would lead to a component breakdown.

Of course, prior art systems were incapable of predicting breakdowns. Mechanical or electrical failure was frequently the result of long term wear. However, performance degradation was not sensed by prior art systems until it lead to a complete component breakdown and system failure. This would require a process shut down to remove and replace components.

### SUMMARY OF THE INVENTION

In a fluid transmission line, a valve comprises a housing that establishes a lumen having an axial length for transmission of a fluid through said valve; a drive mechanism; a drive gear being mounted in said housing to be selectively driven in a first or second rotational direction by said drive mechanism, said drive gear having a central throughhole coaxial with an axis of said valve; a plurality of pins circumferentially spaced around said central throughhole of said drive gear; a plurality of leaves, each being pivotally mounted on one of said plurality of pins, and oriented to extend radially inward into said central throughhole; a fixed extension having an annular aspect disposed in close cooperation with said drive gear, and said fixed extension having a plurality of engagement members disposed to operatively engage one of said leaves at a position intermediate to said pivotal pin mount of each of said leaves and to said axis of said valve; said engagement members biasing said leaves to close an orifice when said drive gear rotates in said first direction and to open said orifice when said drive gear rotates in said second direction; and each of said leaves maintaining a substantially sealing engagement with each adjacent leaf throughout a range of motion of said plurality of leaves.

The present invention includes a control system for a process valve. It may be comprised of solid state components including logic processors. It may be operated by direct current. It includes a controller and an algorithm programmed into the controller. These components may or may not be integrated with a particular motor and/or a particular valve, such as the iris valve depicted herein. The control system relies upon a memory of a time of operation of an actuating motor to control the motor and valve. The actuating control system of the present invention may be installed to respond to any sensed process parameter, including for example temperature or pressure. When a process parameter is received, it is compared to a last sensed reading and a difference is calculated. Thereafter a time T of motor operation necessary to reach the user input set position for the process parameter is calculated and a corresponding signal output to the motor.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic side view of a prior art valve system.

FIG. 2A is an interior view of one side of a housing.

FIG. 2B is an exterior view of another side of a housing.

FIG. 3A is an isometric view of the main gear of the valve.

FIG. 3B is an opposing isometric view of the main gear of the valve.

FIG. 4 is a cutaway side view of the main gear and iris of the valve.

FIG. 5 is an isometric view of a single leaf of the iris.

FIG. 6 is a partially disassembled isometric view of an alternate embodiment.

FIG. 7 is a partially disassembled cutaway top view of an alternate embodiment.

FIG. 8 is a cutaway side view of an alternate embodiment.

FIG. 9 is an isometric view of a second alternate embodiment.

FIG. 10 is a first isometric view of a third alternate embodiment.

FIG. 11 is an opposing isometric view of the third alternate embodiment.

FIG. 12 is a circuit diagram of a novel feedback circuit for the present invention.

FIG. 13 is a box diagram of control system.

FIG. 14 is a flow chart of Reset Routine.

FIG. 15 is a flow chart of Automatic Adjustment Routine.

FIG. 16 is a circuit diagram of control system.

FIG. 17 is a circuit diagram of control system.

FIG. 18 is a flow chart of a self diagnosis routine.

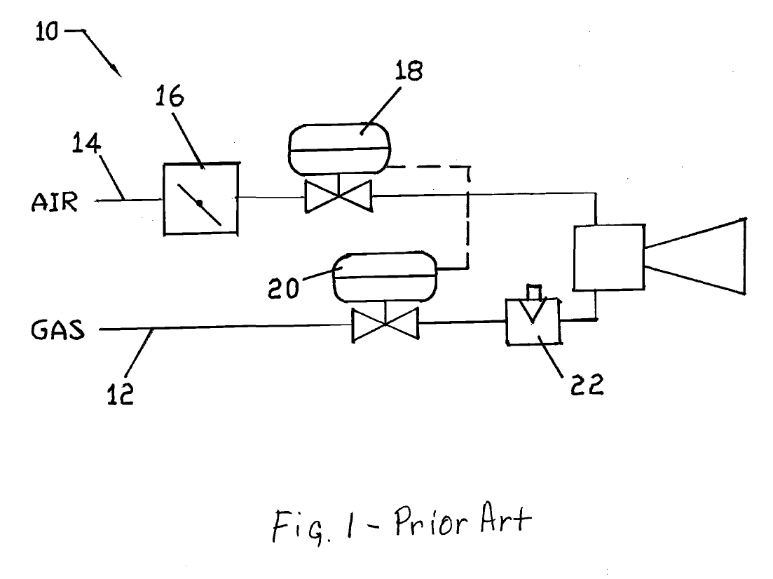

### DETAILED DESCRIPTION OF THE PREFERRED EMBODIMENTS

The following description of the preferred embodiment(s) is merely exemplary in nature and is in no way intended to limit the invention, its application, or uses.

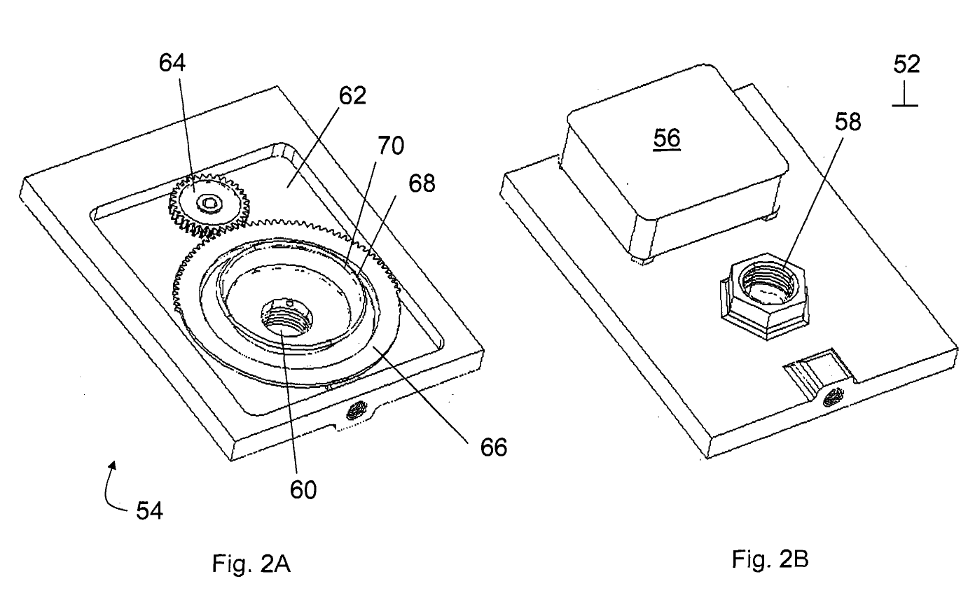

FIGS. 2A and 2B depict a housing comprised of a housing top 52 and bottom 54 portion which house the valve of present invention. Housing top 52 includes a seat 56 for a drive motor. Housing top 52 and bottom 54 include through holes 58 and 60, respectively, for mounting a pipe or line through which a fluid or gas may be directed. The line may be a natural gas line. In the depicted embodiment, a recess 62 is shown in the housing bottom 54 for containing the hereinafter described components. The valve housing consists of two plates. Each plate has a hexagonal pipe-fitting boss on one side, and is threaded with a standard NPT thread. The opposite side of each housing contains features for the alignment and mounting of the internal valve components, namely the iris assembly, the drivetrain gears, and the sealing mechanisms. There are features on the inside of one of the housing plates which allow mechanical fastening of a motor/electrical control interface. The two housing plates mechanically fasten together.

A motor (not shown) housed in recess 56 will drive a drivetrain, which in the depicted embodiment is a drive gear 64 which in turn is drivingly engaged with a main gear 66. Assembled coaxially with main gear 66 and through holes 58 and 60, is a bushing 68 having an annular extension. In the depicted embodiment, the bushing has a seal 70, an O-ring is depicted, for sealing against a flush face of housing top 52. In the embodiment depicted in FIG. 2, main gear 66 has a sufficient number of teeth to correspond with the full range of motion for the valve leaves, described below. The opposite face of the gear has a protruding boss. The gear has a throughhole through the center. The boss is positioned within a counterbore in the housing, which allows the gear to freely rotate.

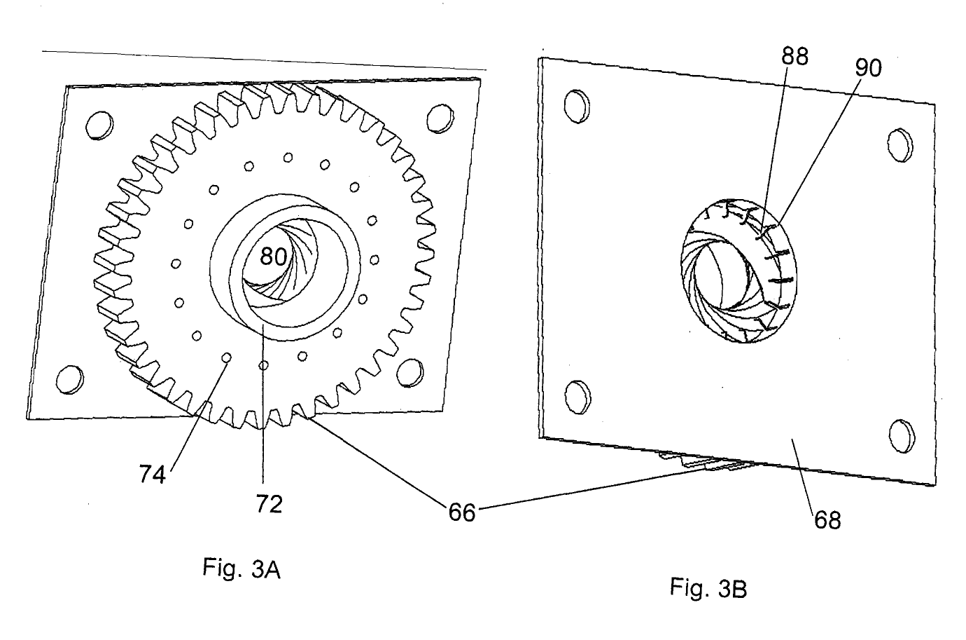

FIGS. 3A and 3B are close-ups of the main or iris gear 66. In the embodiment depicted in FIGS. 3A and 3B, the entire circumference of main gear 66 is toothed. FIG. 3A depicts an upstream facing surface of main gear 66. This surface includes a boss 72 dimensioned to seat in sealing fluid communication with through hole 60 in housing bottom 54. Also depicted in 3A are pin holes 74.

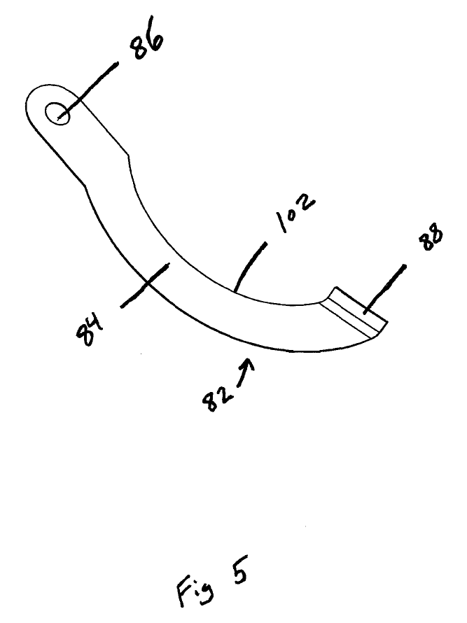

As seen in FIGS. 3A and 3B a valve orifice 80 is defined by a plurality of leaves. An individual leaf 82 is depicted in FIG. 5. In the depicted embodiment there are 16 leaves. Each of the depicted leaves 82 has a substantially flat, curvilinear portion. A first end of the leaf 82 has a through hole 86 for receiving a pin for mounting the leaf 82 under the main gear 66 in a pivoting manner. The second end of leaf 82 terminates in a fin or flange 88 (FIG. 5). In the depicted embodiment, the fin 88 is substantially perpendicular to the plane of the curvilinear portion 84. It is within the scope of the present invention that the flange 88 may be at an angle to the curvilinear portion 84 of the leaf within a range of substantially about 90° to substantially about 135°. Those of skill in the art will appreciate that the use of a flange allows for overlapping leaves, including multiple overlaps, that is, more than two leaves overlapping one another relative to the longitudinal axis of the valve. This feature, independently or in combination with the integral fabrication of the gear 66, allows the design to be used in high pressure applications as well as other more abusive environmental conditions, such as high temperature or corrosive fluid flow, and promotes tighter sealing. Portions of the leaves, such as curvilinear portion 84, may be flared, twisted, torqued or otherwise non-planar to further promote a sealing engagement with neighboring leaves.

The leaves may be made from two different materials, and arranged so that each leaf is a different material than the adjacent leaf. Physical forces, such as magnetism, or an integral torsion in each leaf, bond the leaves together while allowing them to slide relative to each other.

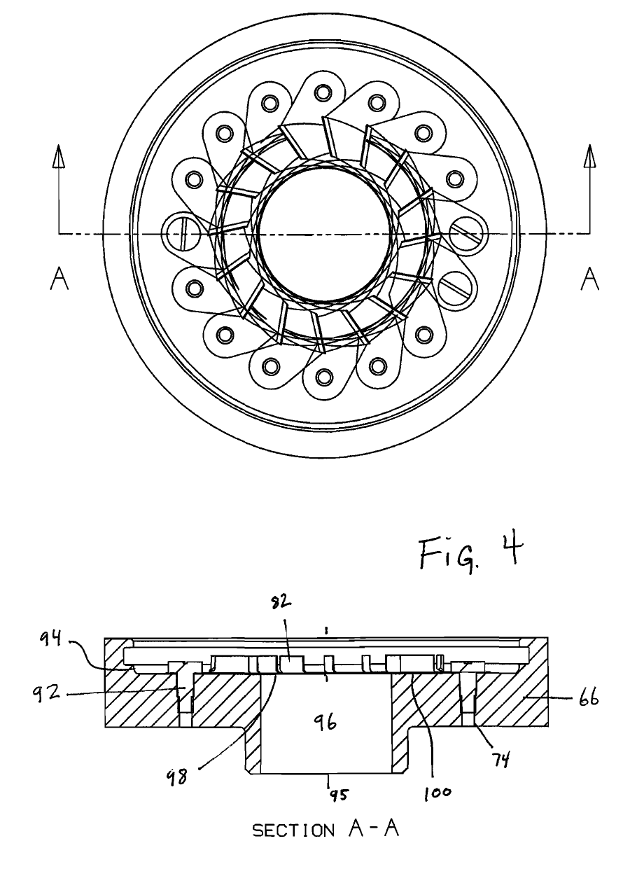

FIG. 4 is a cutaway side view of main gear 66 including a through hole 96 which is centered on valve axis 95 and define a part of a lumen through which a fluid material would flow. Also depicted are pin holes 74 and pins 92 installed therein. The pins are long enough in axial direction to also anchor leaves 82 in their engagement with pin holes 86. At least a portion of a lower surface 98 of each leaf abuts an upper surface 100 of a recess 94 in main gear 66. This abutment is sufficient to maintain a seal. The seal is in turn sufficient to maintain itself against the anticipated use of the installed device. Fixation of leaf 82 to main gear 66 with pin 92 may be adjusted for an appropriate tractive force to be applied against leaf 82 by pin 92 in order to maintain sealing abutment.

In assembly, each leaf 82 is pinned to main gear 66. Each leaf thereafter has fin 88 projecting axially, downstream in the depicted embodiment. Thereafter, a bushing or extension 68 is installed on top of the plurality of leaves 82 such that each axially projecting fin 88 is received into each of a plurality of slots 90 in bushing 68. The flanges of the leaves are guided within slots in the bushing or extension 68. This guide extension 68 fixedly locks into the housing to prevent rotation. A protruding ring has the thin slots cut for the leaf flanges to engage. Another ring may provide a sealing surface.

In the depicted embodiment, when assembled, each pin is substantially equidistant radially to the center axis 95 of the through hole 96 and orifice 80 of the valve. Correspondingly, slots 90 are also substantially equidistant radially, and substantially equally spaced circumferentially in the depicted embodiment. Each fin is also substantially linear in the depicted embodiment. The assembled components of leaves 82, bushings 68 and main gear 66 are thereafter further installed with O-ring 70 into recess 62 of housing bottom 54. The main gear 66 engages with drive gear 64. Bushing 68 is fixedly attached to housing top 52 by means of a key and slot, boss and detent, snap fit, screws or otherwise. The motor and housing top 52 assembly is thereafter installed over housing bottom 54 thereby encapsulating the components.

The drive mechanism may consist of an electric gear motor, either electrically powered, capable of being driven in both the forward and reverse directions. The motor has two output shafts. The primary output shaft penetrates one of the housing plates to drive the iris diaphragm through the drivetrain. The secondary output shaft is used for valve position sensing. The valve may also be manually adjustable, through the use of a lever, worm screw, etc.

In operation, a drive motor turns drive gear 64 in response to either automatic control or user selection. Drive gear 64 through its meshing engagement with main gear 66 turns main gear 66. Bushing 68 does not rotate. As drive gear 66 rotates, the second inner end of each leaf 82 is held fixed against circumferential displacement by engagement of the fin 88 with its corresponding slot 90 of fixed bushing 68. As the main gear 66 rotates, it circumferentially turns the outer end of each leaf 82. Each leaf 82 rotates around its pin hole 86. Accordingly, traction on each leaf 82 through pin 92 by main gear 66 causes each leaf to advance radially inward. As main gear 66 is driven in a first direction, each of the plurality of leaves moves inward. That is to say, an inside edge 102 each leaf advances in a manner reducing the distance between the inner edge 102 of the leaf and a center axis of orifice 80. Accordingly, orifice 80 closes.

To open the orifice 80 and allow a larger volume of fluid or gas to pass therethrough, main gear 66 is driven in an opposite direction. Each leaf is thereby driven by its pin hole 86 against the slot 90. Engagement of each fin 88 against slot 90 causes the leaf to move radially outward from the center axis of the orifice 80, thereby opening it. Accordingly, a dual polarity motor may provide driving force in each of two directions in order to selectively open and close the orifice 80 through which fluid or gas flows.

In the depicted embodiment, the 16 leaves form an orifice that is substantially circular. The iris type configuration depicted provides for the orifice to remain symmetrical, and as depicted substantially centered on the valve axis throughout variations in its size or variations in the flow volume through it. As such, the valve provides a mathematically predictable proportion between orifice size and flow volume. Because the orifice is centered on the lumen defined by the housing and geometrically symmetrical, the flow of fluid or gas through it is much more directly proportional to the opening or closing of the orifice 80 than prior art valves. Accordingly, a more precise control of flow may be achieved. Laminar flow of fluid is re-established immediately after the orifice and may be established within the lumen of the valve itself, minimizing turbulence as the fluid exits the valve.

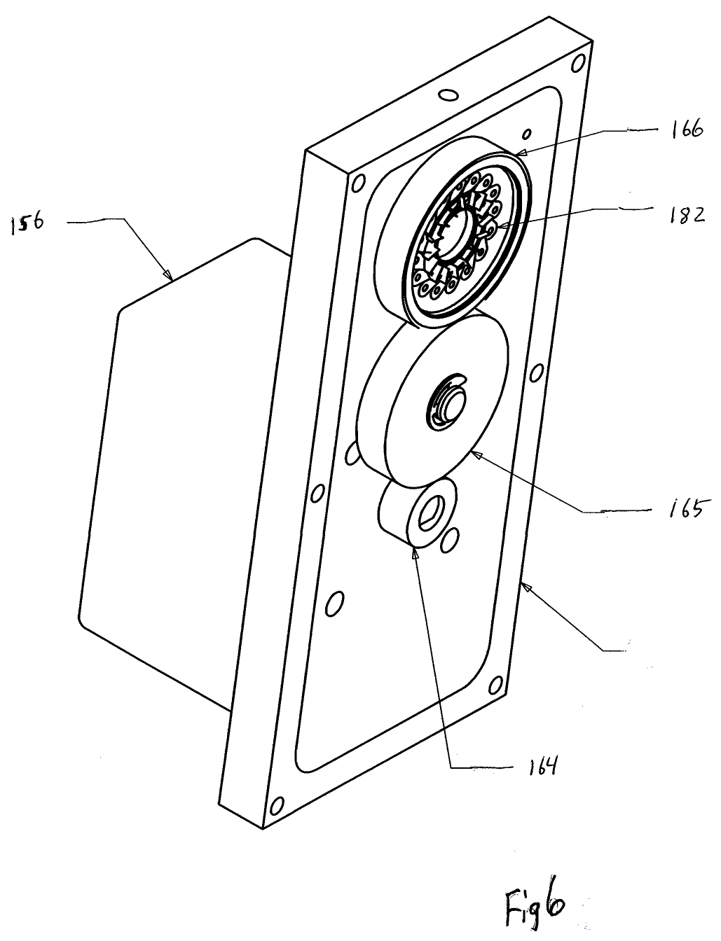

FIG. 6 depicts an alternate embodiment of the present invention. It includes a housing 156 supporting a drive gear 164 driven by a motor in the housing 156, which is obscured from view in the partially disassembled FIG. 6. As above, a main iris gear 166 has a plurality of leaves 182 mounted thereon. Gear 166 has an annular recess dimensioned to receive a bushing or extension (not shown in FIG. 6) having guide members such as slots for biasing the leaves 182 towards constriction or expansion in response to rotation of iris gear 166. In the embodiment depicted in FIG. 6, the driving force is transferred from drive gear 164 to iris gear 166 through transfer gear 165.

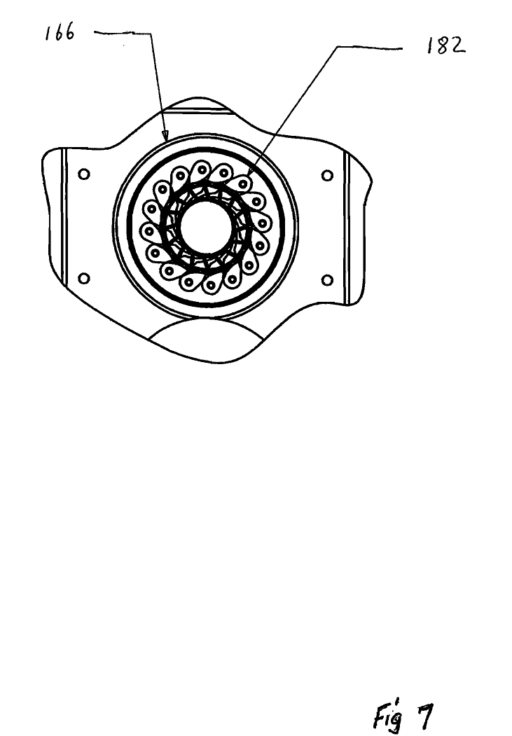

FIG. 7 is a top, partially disassembled, cutaway view of the iris gear 166, depicting the deployment of sixteen leaves 182.

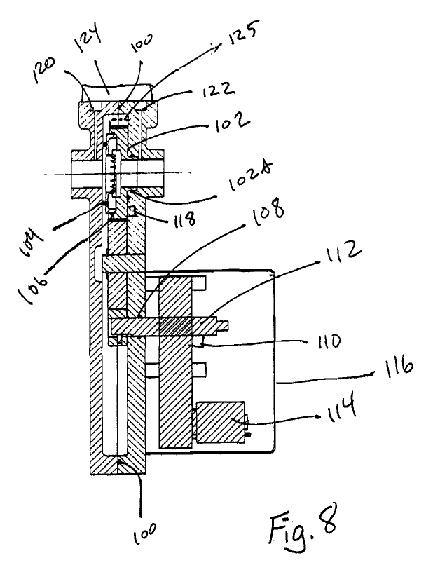

The sealing system is best seen in FIG. 8. The sealing system consists of several resilient gaskets, such as O-rings. The primary housing seal 100 is of a contoured shape, and rests within a groove in one of the housing plates. This seal engages the opposite housing plate when assembled. The fluid channel seal consists of two O-rings. One seal 102 (optionally, 102A) rests in a groove in the housing plate and engages the surface of the main iris gear 166 near the protruding boss. The other seal 104 rests in a groove in the other housing plate and engages the surface of the diaphragm guiding extension or bushing 168. There is also a seal 106 within the iris gear 166, which seals between the iris gear and the guide extension 168. The shaft sealing system consists of two O-rings that engage the drive motor shaft. One of these O-rings 108 rests in a groove inside of one of the housing plates. The other O-ring rests in a groove on the outside of one of the housing plates. All sealing system components are compressed when the mechanism is fully assembled.

Each housing plate 156 may also contain passages 120, 122 through which the differential pressure across the iris can be measured, either internally within the valve or through an external device. The valve may also contain an electronic differential pressure transducer which provides actual flow characteristic feedback. Also shown in FIG. 8 is a cam 110 for engaging limit switches as an optional control modality.

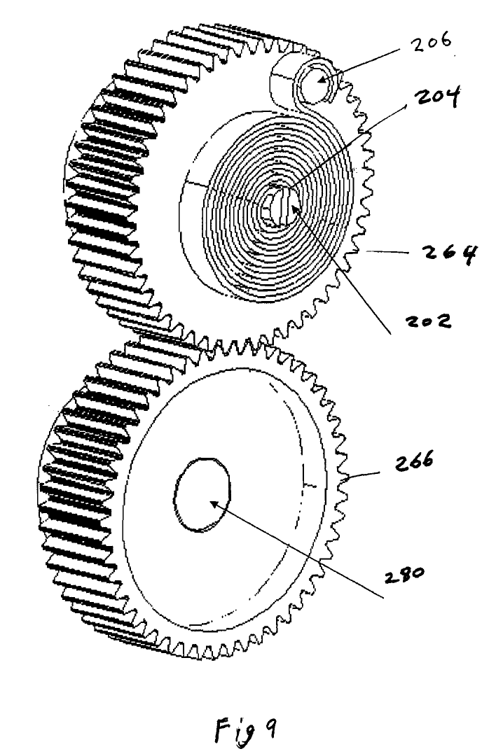

FIG. 9 depicts an alternative embodiment of the present invention. In the depicted embodiment a bi-metal torsion spring drives the drive gear. Differential expansion and contraction of the two metals comprising the spring in response to temperature changes causes the metal strip to expand and contract rotationally, imparting drive when mounted as depicted. The center shaft 202 of drive gear 264 is fixed to the housing and remains stationary. The drive gear 264 is mounted to rotate around it. The internal end of bi-metal torsion spring 204 is fixedly attached to anchor shaft 206. Anchor shaft 206 is fixedly attached to or integrally formed with drive gear 264 at or near its outer edge. Bi-metal torsion spring 204 is attached at its outermost end to anchor shaft 206. Accordingly, expansion of bi-metal torsion spring 204 biases anchor shaft 206 and drive gear 264 in a first direction and contraction of bi-metal torsion spring 204 biases anchor shaft 206 in order to turn drive gear 264 in an opposing direction. As described hereinabove, rotation of drive gear 264 imparts counter rotation to the main or iris gear 266. Rotation of iris gear 266 opens and closes orifice 280.

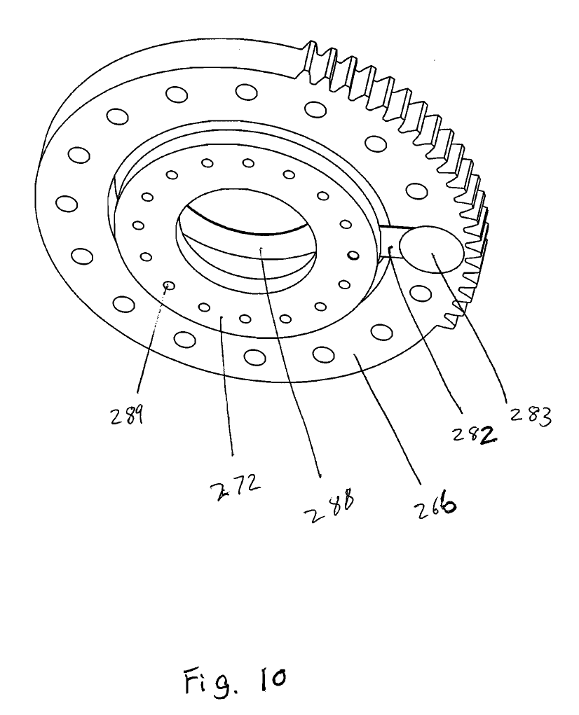

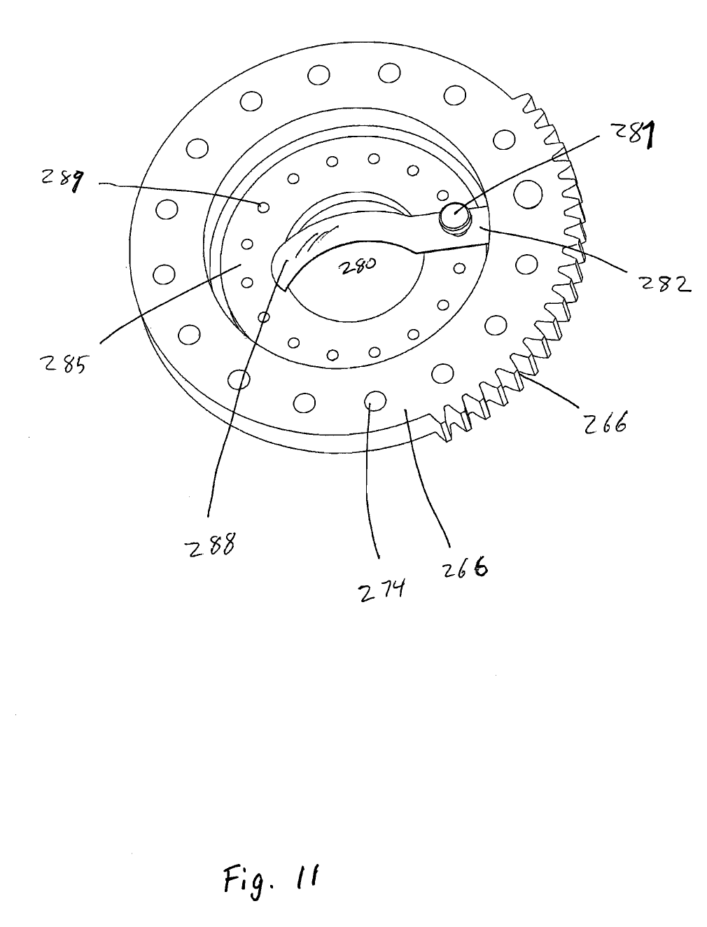

FIGS. 10 and 11 depict an alternate embodiment of the present invention. The drive gear 266 is driven through engagement of its teeth with the drive gear as described hereinabove. The iris leaves 282 are attached as before to pins 283, which are pivotally mounted in drive gear 266 in throughholes 274. In the embodiment depicted in FIGS. 10 and 11, the leaf 282 does not have a flange, vane or fin at its inner terminal end as in the previous embodiments (although it may be flared, twisted or otherwise non-planar in order to promote a sealing engagement with its neighboring leaves). Instead, the fixed valve mount includes an annular extension or bushing 272 that has a smaller diameter than the center hole of the drive gear 266 and extends axially into it. This annular extension 272 also has leaf engagement members that are pin holes 289 circumferentially spaced around its perimeter, which serve as mounts for pintels 287 which are pivotally engaged in the holes 289 and also through the leaves 282. Since the annular extension 272 is fixed, when the drive gear 266 rotates in either direction, the pivotal attachment of each leaf 284 to its drive gear pin 283 will cause the leaf 282 to be rotated in one direction or the other around inner pintel 287. Accordingly, the orifice extension 288 of each leaf will be rotated such that the orifice 280 will be opened or closed.

In the depicted embodiment, sufficiently wide tolerances are allowed in the pin 283—throughhole 274 and/or pin hole 289—pintels 287 relationships to allow opening and closing of orifice 280 despite the fixed coaxial relationship of iris gear 266 and extension 274.

The electrical control interface consists of multiple functional components. In one embodiment the main control interface consists of a sealed multi-pin plug. This plug may be wired to a printed circuit board. The PCB contains two DPDT relays which allow for switching of the polarity of the input drive signal. The primary PCB also contains limit switches that indicate the valve position sensed from a mechanical positioning device attached to the secondary output shaft. The primary PCB may also contain limit switches which detect (as by cam 110) and control the travel limits of the drive system which can be positioned by a user. In one embodiment, a secondary PCB is wired to the primary PCB. The secondary PCB contains electronic control architecture which allows the reception, interpretation, and use of one of several standard control signals, such as 4-20 mA, 0-10 Vdc, etc. for valve position, see below. The entire electronic control package may be physically contained within a protective cover, which is physically attached to one of the housing plates. There is a seal between the protective cover and the housing plate. There may also be indicators, which may be mechanical or electrical, on the housing which relay status of the valve position. There may also be a rotary position sensor 118 which provides valve position feedback to a supervisory control system.

The present invention provides for a mathematically predictable flow according to the equation:

$$flow = K A \sqrt{\frac{h}{g}} ,$$

in which K is a constant particular to the valve design. A is the area of the orifice, h is the pressure drop across the orifice, and g is the specific gravity of the fluid or gas flowing through it.

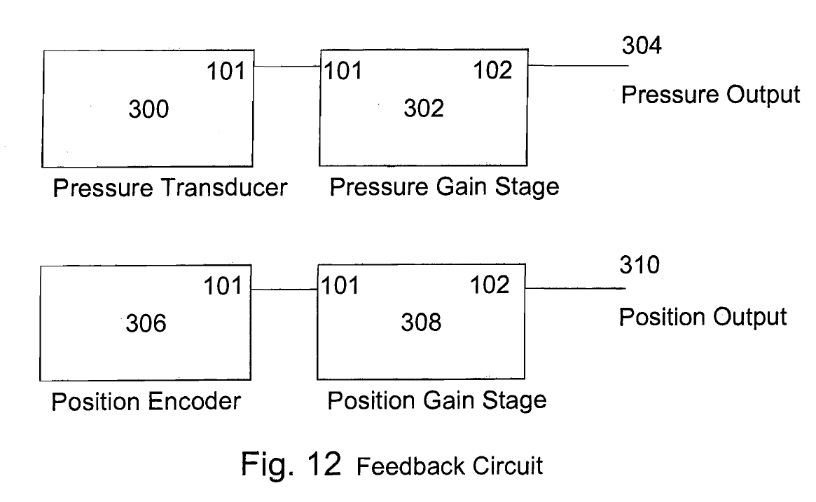

FIG. 12 depicts the novel feedback circuitry of the present invention. A pressure transducer 300 (see 124 in FIG. 8) is operatively engaged with pressure sensor port 120. The pressure transducer 300 signals a pressure gain stage 302 to yield a direct pressure reading output 304. Alternatively, a pressure differential output can be generated by incorporating a second pressure transducer operatively engaged to the second pressure sensor port 122 on the opposite of the valve orifice.

In order that the present invention may be incorporated into devices using an alternate control regimen, the feedback circuits also include a position encoder 306 operatively engaged with the drive train, usually at the motor shaft (see 125, FIG. 8). It too feeds into a position gain stage 308 in order to yield a position output 310. Such a position output 310 may be used with the equation

$$flow = K A \sqrt{\frac{h}{g}} ,$$

in order to yield a cubic feet per hour corresponding to a percent that the valve orifice is open.

Control System:

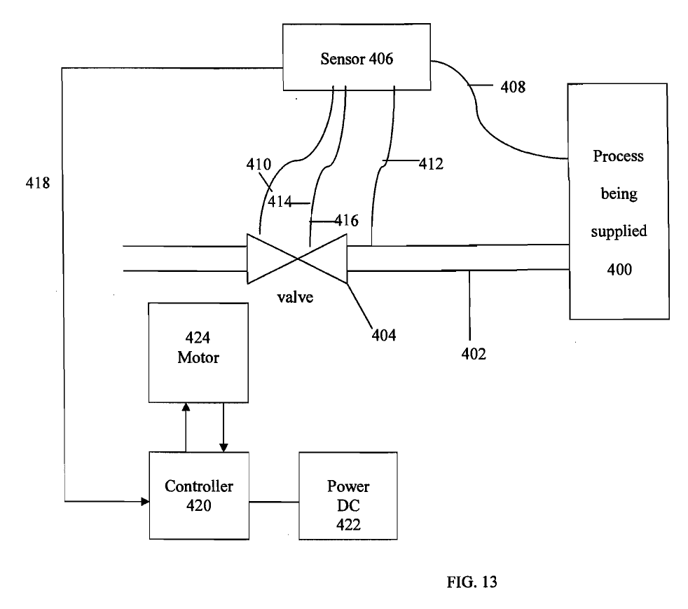

FIG. 13 is a box diagram illustrating the components of the control system of the present invention. A process being supplied 400, for example a furnace, is supplied by a pipe line 402 through which a fluid material, for example gas, is being supplied to the process 400 through the valve 404 and the control system of the present invention. The process being supplied and/or the supply of the fluid to it is monitored by a sensor 406. The control system of the present invention can be configured to work in conjunction with and in response to a wide variety of sensors. This could include a thermocouple 408 monitoring the process itself, or it could include upstream flow meters or pressure sensors 410 and/or downstream flow meters or pressure sensors 412. It may also incorporate a flow meter or pressure transducer incorporated with the valve 404 which may include an upstream sensor 414 or downstream sensor 416.

The sensor 406 may receive and store a set point from an operator. Several sensor systems are known in the art and may be comprised of any sensing equipment without departing from the scope of the present invention. The sensor 406 also correlates the parameter being measured, temperature, pressure or flow rate, for example, with a valve position preconfigured to correspond to varying levels of the parameter being measured. For example, sensor 406 may be preconfigured to correlate a user input set point for a process temperature with a steady state valve opening position. For example, a set point of a furnace temperature of 3000 degrees may be preconfigured to correspond to a 50% open position for the valve 404. While not limited to the following, those with skill in the art will understand that most sensors 406 are configured to output a logic signal, usually in one of three standard ranges; zero to 5 volts, zero to 10 volts, or 4 to 20 mA. Sensor 406 has an output 418 which the controller of the present invention is configured to receive.

The controller 420 of the present invention receives a DC power supply 422. It is in operative communication with a motor 424 which drives valve 404. The motor, valve and controller may be assembled as a modular unit, or any two of the motor, controller or valve may be assembled as a modular unit, or the three components may be manufactured and deployed separately.

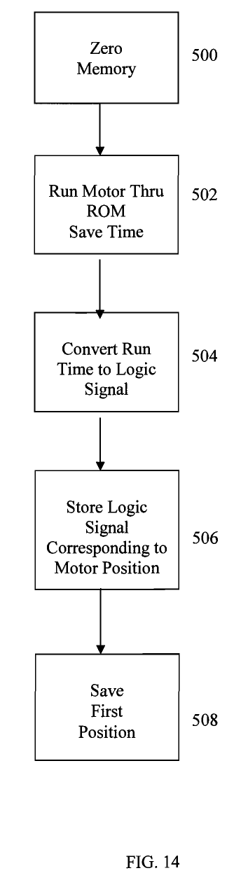

The controller 420 of the present invention is configured to execute a reset routine, an automatic adjustment routine and a self-diagnosis/maintenance algorithm. The reset routine is depicted in FIG. 14. The reset routine allows the controller to be deployed to cooperate with any combination of motor support valves. In a preferred embodiment, the valve would be a circular lumen configuration as described hereinabove. The reset routine begins by clearing a memory 500. In an initialization step 502 the motor which the controller will control is set to fully closed or fully open and moved through its entire range of motion. The time necessary to move through 100% of its range of motion is measured. The total run time is used to convert and correlate run time to corresponding logic signals in step 504. For example, if the total travel time of the motor from zero to 100% takes 32 seconds, and the logic signal regime is 4 to 20 mAs, then 1 mA is designated as equivalent to two seconds of motor operation. This logic signal correspondence is then saved in memory, 506. Also saved is the initial position of the motor in step 508. From this reset initialization of the controller 420, an automatic adjustment of the motor and valve in response to input logic signals from the sensor 406 may be executed.

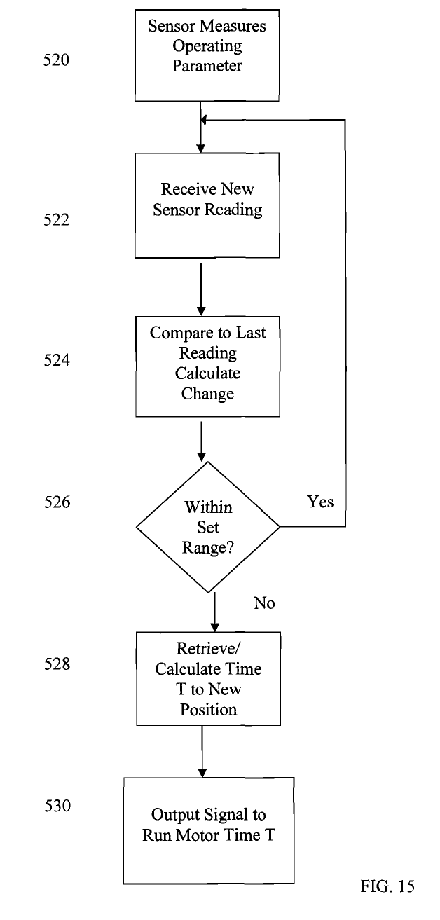

The automatic adjustment routine is depicted in FIG. 15. In it the sensor 406 measures the operating parameter of interest in step 520. This is forwarded through operative connection 418 to the controller 420. The controller 420 receives the new sensor reading 522 as a logic signal. The new logic signal corresponding to a sensed operating parameter measurement is compared to the last stored logic signal corresponding to a last known motor position and a difference is calculated 524. Logic signals received typically may already be expressed as a logic signal corresponding to a motor position. For example, if after an initialization reset routine the position of the motor was left at 50% open, in a 4 to 20 mA logic signal regime, the stored motor position logic signal would have been 12 mAs. If the new sensor reading input at step 522 calls for a motor position of 75%, this would be reflected in the perceived new sensor reading at step 522 being a 16 mA signal. At step 524 the controller calculates the difference of 4 mAs.

In step 526 the calculated delta A or distance between last known motor position logic signal and the newly received, ordered motor position logic signal is compared with threshold settings which are preconfigured to bracket the last known motor position logic signal for purposes described below. If the calculated difference delta A between the current motor position logic signal and the last known motor position logic signal is outside the range of the threshold settings, the controller generates a time T to the new motor position called for by the newly received sensor reading in step 528. Step 528 may be executed either as a new calculation executed on each occasion by a microprocessor by referring to stored logic signal correspondence in memory from step 506. In the alternative, step 506 in the reset routine may comprise creating a look up table of all possible times from each possible last known motor position logic signal to each possible newly received motor position logic signal. In this event, a time T to a new motor position is simply retrieved from the look up table. In either case, a logic signal corresponding to a time duration for which the motor must run in order to reach its newly ordered position, together with the direction, is generated at step 528.

In step 530, a logic signal equal to the calculated or retrieved delta is output to the motor, which is run for time T. In the example, the time T generated in step 528 would be a 4 mA signal, corresponding to 8 seconds of run time. The direction of motor operation is determined by whether or not the comparison made between the newly received motor position logic signal and the last known motor position logic signal at step 524 was positive or negative. In this way, by using time to monitor the motor position, and correspondingly the valve position, and using time to control changes in the motor and valve positions, the control system of the present invention advantageously dispenses with the need for frictional sensors such as slip rings, potentiometers and other moving parts necessary in the prior art, thereby correspondingly improving product durability and reliability.

The control system of the present invention may also be advantageously configured to suppress flutter, a common problem in prior art systems. Flutter is the consequence of the control system unnecessarily cycling in response to trivial variances in the sensed parameter. In step 526 of the depicted embodiment, an optional configuration is added which sets a high and low threshold on bracketing the last known motor position logic signal. For example, 0.5 mAs may be said threshold. If the difference between the newly received motor position logic signal and the last known motor position logic signal calculated in step 524 is only 0.25 mAs, then at step 526 this calculated difference will be determined to be within the set range, for which no response by the controller, motor or valve is desired. If the calculated change from step 524 is within the set range 526, the auto adjustment routine ends for the present sensing cycle and returns to the ready position until a next sensor reading is received. The range may be set more broadly or more narrowly by a user in order to accommodate variability among the various processes being controlled.

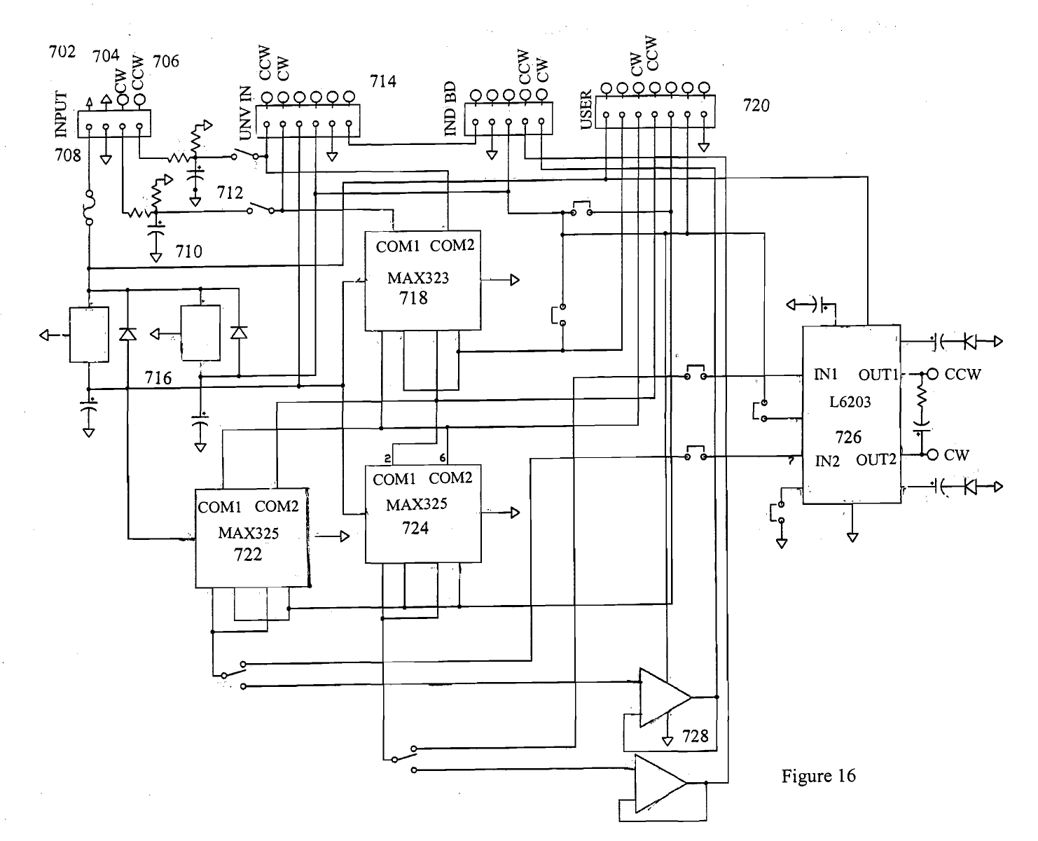

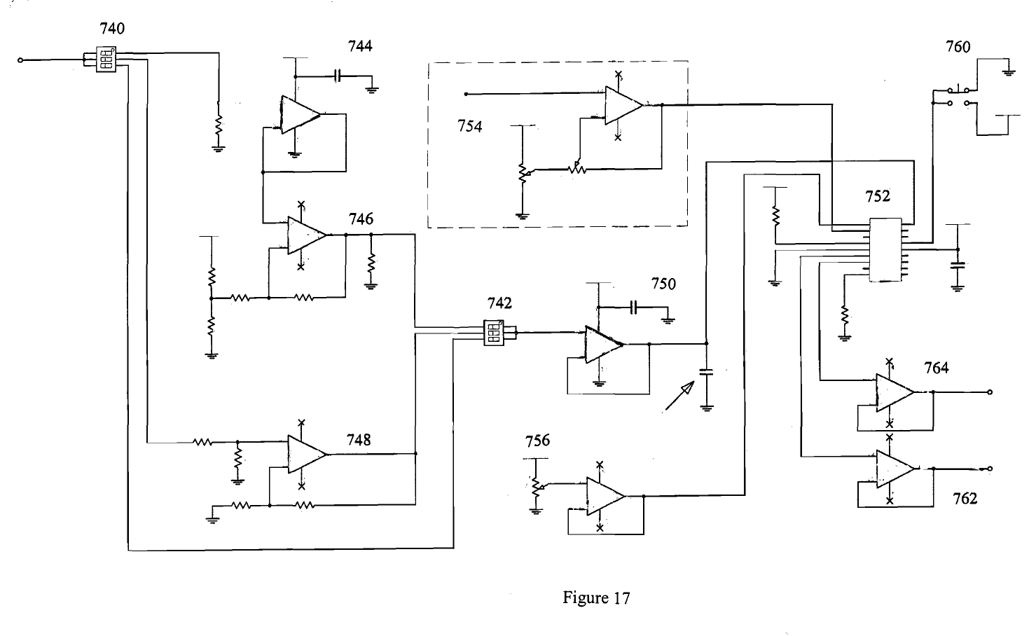

FIG. 16 is a circuit diagram of the baseboard of the control system of the present invention. Inputs into the circuit include a ground 702, a direction signal either clockwise or counterclockwise 704, 706 and a 24 volt power input 708. The direction signals are converted into a logic signal with resistor assembly 710. A pair of switches 712 transmit the logic signal for the direction through to the universal input 714. If both switches are closed, the direction signal 704 and 706 are used. If both switches are open, the universal input 714 is used to control motor direction. Universal input 714 will receive input from the circuit depicted in FIG. 17.

A paired regulator circuit 716 will regulate power input.

Chip 718 actuates switching from manual to automatic mode. In manual mode a user may input the settings and data through user interface circuits 720. In automatic mode logic signals are passed through.

Paired chips 722 and 724 control a direction of rotation of the motor and valve, either clockwise or counterclockwise. These may be wired as depicted, such that a high input will actuate a direct drive in order to move the motor clockwise and a low input will invert the signal in order to drive the motor counterclockwise to either open or close the valve. Driver 726 outputs either the clockwise or counterclockwise signal to the motor and retransforms the signal from a logic voltage to a 24 volt output to the corresponding pins of the motor. Op amps 728 control indicator lights on the user interface circuit 720.

FIG. 17 depicts the logic circuitry for the control system. An analog signal from outside sensor 406 is received at input 740. This will be converted to a zero to 5 volt logic signal to be input to the remainder of the logic circuitry at switch 742. This will be executed by op amp assembly 744 for 746 for 748 according to the regime of the input signal. Op amp assembly 744 will be used for a 4 to 20 mA signal. Op amp assembly 746 will be used for the zero to 10 volt signal and op amp assembly 748 will directly pass through a zero to 5 volt signal if the signal is received as such. In this way, a logic signal representing a motor position as it should be set to respond to a sensed operating parameter, for example temperature, according to outside sensor 406 will be received in the logic circuitry. After being converted to zero to 5 volts op amp assembly 750 will further condition the input signal and pass it through to the programmable integrated chip (PIC) 752. Also input into the PIC 752 will be input from the rotary position sensor 754 which is part of the control system in the depicted embodiment. This input is received from the circuitry depicted in FIG. 12. This input represents an actual indication of where the motor and/or valve is positioned at any given moment. Potentiometer 756 and op amp assembly 758 receive from a user interface the user's measurement of the time it takes for the motor to run through its entire range of motion, in order to execute step 502 in the reset routine. As explained hereinabove, this initialization will be stored in a memory in the PIC 752 for use in the algorithm as described.

A reset switch 760 may be used in the event of power outages or an event which interrupts current to the circuit. In this manner, after such an event the PIC 752's memory of the last known motor position may be reestablished. The reset switch 760 will reset the motor and/or valve at fully open (or, optionally, fully closed).

Accordingly, through the logic circuits, PIC 752 may execute the reset routine with the signal received from op amp assembly 758, may execute the automatic adjustment routine with the signals received throughout op amp assembly 750 and may execute the self-diagnostic routine with the signals from both op amp assembly 750 and the rotary position sensor 754.

The PIC 752 outputs a direction control instruction through op amp pair 762. If the motor and/or valve is not to be moved on a particular cycle, there is zero input. If the flow is to be increased, a signal is sent to the open relay control 762 and if the fluid flow is to be decreased, the signal is sent to the closed relay control 764. These inputs then proceed to universal input 714 depicted in FIG. 16 for execution.

The failure of valves and the motors that drive them are seldom catastrophic and sudden. More commonly constant wear will cause seals to erode or particular leaves in a valve to fail to seat properly or a gear tooth may slip. Accordingly, there is frequently a degradation of performance in advance of outright failure of the component. The control system of the present invention includes a self-diagnosis routine designed to take advantage of these typical wear and failure progressions to anticipate serious breakdowns. Components may then be replaced during regularly scheduled shut downs of the process in which the valve operates. The self-diagnostic routine is therefore directed towards perceiving small degradations in performance.

The self-diagnostic routine makes use of a look up table which stores a correlation between a known range of valve and/or motor positions and known theoretical performance parameter values that should ideally result from each valve/motor position. Periodically, sensed performance levels are measured. The performance parameter level measured is retrieved from this look up table, along with the motor and/or valve position with which it is ideally correlated. This value for what the valve/motor position should be is then compared with the actual valve/motor position, which is received from the position encoder 306 from FIG. 12 through rotary position sensor circuit 754 in FIG. 17 above. In the event the actual motor position diverges from the correct motor position for the currently sensed performance parameter, a problem will be diagnosed and a signal sent to a display to alert an operator. With this knowledge, the components may be inspected and if necessary replaced during the next scheduled shut down of the process.

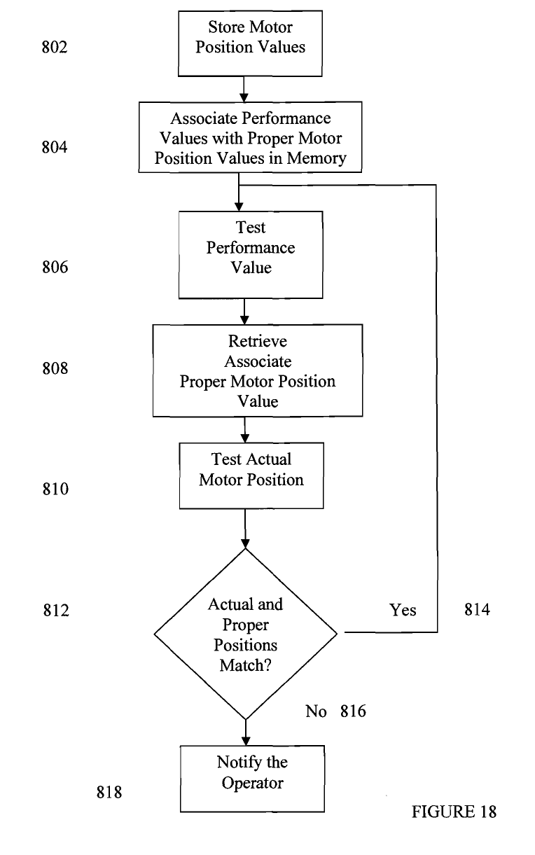

FIG. 18 is a flow chart of the self diagnosis routine. In initialization, motor position values are stored 802 in a memory. Proper performance values are then associated with the positions 804 and stored in memory, correlating performance values with an ideal motor and/or valve position expected to produce those performance values. In operation, a performance parameter is tested to obtain a performance value 806. A motor/valve position value associated with the measured performance parameter value is retrieved 808. Actual motor/valve position is measured 810. (Steps 808 and 810 are interchangeable without departing from the scope of the invention.) The actual and ideal motor/valve positions are compared 812. If the same, the routine ends and waits for a next periodic test, 814. If they do not match, then the present motor/valve position is not yielding the proper performance parameter value. Hence, if they do not match, a signal is output 818 to notify an operator of a possible problem, as for example by a display indicator.

In one embodiment the performance parameter may be a pressure differential. This may be calculated as the difference between an upstream pressure transducer 410 or 414 from FIG. 13 and a downstream pressure transducer 412 or 416. The processor then retrieves an ideal position where the motor and/or valve should be by retrieving that position from the look up table, where the ideal position is stored in association with the calculated pressure differential. The retrieved ideal motor/valve position is then compared to an actual motor/valve position. If different, a signal is output to actuate a notice display for a user. The difference between actual and ideal position that generates a warning may be a difference in excess of a threshold.

The look up table may be populated in an initialization step manually, by an external sensor, or by pressure sensors built into the valve/motor/controller assembly. Initialization may be at installation or later.

Thus, the present inventive mechanisms and controls provide greater precision for all gas or fluid control systems, including but not limited to trim gas flow in combination with protective atmospheric gas such as endothermic gas.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A control system for a valve having a motor, said control system comprising:
a processor configured to store in a memory a first valve motor position and a motor position rate of change;
an input for said processor whereby said processor may receive a signal associated with a second valve motor position;
when said second valve motor position is different from said first valve motor position, said processor being configured to generate a signal indicating a time of motor operation and a direction of motor operation for output to a motor such that a valve motor receiving said signal moves to said second motor position.

2. The valve controller of claim 1 wherein said direction indication of said output signal is through a first circuit path for a first direction and through a second circuit path for a second direction.

3. The valve controller of claim 1 wherein said generation of a time of motor operation is by calculating a time from a last known valve motor position and said rate of change.

4. The valve controller of claim 1 wherein said stored rate of change is a stored time for the valve motor to move through 100 percent of a range of motion for the valve motor.

5. The valve controller of claim 4 wherein said stored time for the valve motor to move through 100 percent of its range of motion is input from a user at an initialization of said processor.

6. The valve controller of claim 1 wherein said storing of said rate of change is storing a time from each possible valve motor position to every other possible valve motor position.

7. The valve controller of claim 6 wherein said generation of said output signal is by looking up a time from said first motor position to said second motor position.

8. The valve controller of claim 1 wherein said first motor position is a last known valve motor position from a preceding cycle.

9. The valve controller of claim 1 wherein said storing is by storing a valve motor movement time for each possible difference between said first valve motor position and said second valve motor position.

10. The valve controller of claim 9 wherein said generation step further comprises calculating a difference between said first valve motor position and said second valve motor position.

11. The valve controller of claim 10 wherein said generation step further comprises said time of motor operation being said time corresponding to said difference.

12. The valve controller of claim 1 wherein said second valve motor position being different from said first valve motor position is determined by said difference being greater than a preconfigured threshold difference.

13. The valve controller of claim 1 wherein said input signal associated with a second valve motor position is received from a sensor controller.

14. The valve controller of claim 13 wherein said sensor controller controls a sensor selected from the group consisting of a flowmeter, a pressure transducer, a thermocouple and a thermometer.

15. The valve controller of claim 1 further comprising a motor.

16. The valve controller of claim 1 further comprising a valve motor and a valve.

17. The valve controller of claim 16 wherein said valve is an iris valve.

18. The valve controller of claim 1 wherein said processor is further configured to generate a signal outputting a warning to a user when a valve motor actual position varies from a valve motor proper position, said valve motor proper position being associated with a sensed operating parameter.

19. The valve controller of claim 18 wherein said generation of said warning signal wherein said warning signal is generated when said processor calculates a difference between an input second valve motor position and an actual present valve motor position.

20. The valve controller of claim 19 wherein said actual present valve motor position is received from a signal from a rotary position sensor.
